(19) United States
(12) Patent Application Publication
(10) Pub. No.: US 2013/0219044 A1
(43) Pub. Date: Aug. 22, 2013

(54) Correlating Execution Characteristics Across Components Of An Enterprise Application Hosted On Multiple Stacks

(71) Applicants: ARVIND MAHESHWARI, Bangalore (IN); Rishi Saraswat, Hyderabad (IN); Kothuri Anil Kumar, Bangalore (IN)

(72) Inventors: ARVIND MAHESHWARI, Bangalore (IN); Rishi Saraswat, Hyderabad (IN); Kothuri Anil Kumar, Bangalore (IN)

(73) Assignee: Oracle International Corporation, Redwood Shores, CA (US)

(21) Appl. No.: 13/400,597

(22) Filed: Feb. 21, 2012

(51) Int. Cl. G06F 15/173

(52) U.S. Cl. 709/224

(57) ABSTRACT

An aspect of the present invention provides for monitoring components of an enterprise application distributed across stacks. In an embodiment, a digital processing system receives a monitoring data indicating a first component and a second component of an enterprise application, with the monitoring data further indicating that the first component executes in a first stack and the second component executes in a second stack. The digital processing system collects execution characteristics of the two components and displays the collected execution characteristics of both the components. According to another aspect, the execution characteristics for both the components are displayed on a common user interface for a same time window, such that a user (e.g., an administrator of the enterprise application) is facilitated to correlate the execution characteristics of different components executing across multiple stacks.

### BACKGROUND

1. Technical Field

The present disclosure relates to enterprise systems, and more specifically to correlating execution characteristics across components of an enterprise application hosted on multiple stacks.

2. Related Art

Enterprise applications refer to a group of applications tailored for specific business contexts typically executed on multiple servers for reasons such as scalability, redundancy and performance, as is well known in the relevant arts. Examples of such business contexts include banking, finance, sales, supply chain management, etc.

Each enterprise application is typically implemented based on multiple components. Components refer to executable software modules or application level data structures (i.e., multiple data elements accessible in software instructions by a corresponding logical organization). Examples of such components include, application modules (implementing the business logic), message queues (for inter-component communication), adapter modules (facilitating access to persistent storages such as database servers), tables/databases (storing the persistent information in database servers), etc. An enterprise application can instantiate and execute multiple instances of several component types for processing client requests.

Stacks host components, the effect of which is generally to simplify the implementation and execution of components. With respect to software modules, a (hosting) stack provides a common set of software routines that can be (or caused to be) invoked by each of the component instances for obtaining corresponding logical functions.

On the other hand, stacks hosting data structures provide software routines and other facilities, which simplify creation, access, removal, etc., of the data structures and the elements stored therein. Each stack type thus provides software routines that are specific to the corresponding component types. For example, application server type stacks, middleware type stacks, persistent type stacks and storage type stacks respectively facilitate implementation of application modules, message queues, adapter modules and tables/databases.

Thus component instances designed for execution in a corresponding stack, may invoke (or cause invocation) of the software routines provided by the stack. Each stack can be further shared by multiple enterprise applications, such that the implementation of the components of all such enterprise applications is also simplified.

Execution characteristics are often associated with each component. The execution characteristics provide a measure of the throughput performance and resource usage (e.g., storage related requirements, processing related requirements, etc.) associated with the component during execution of the enterprise application.

There is often a need to correlate execution characteristics across components implemented on multiple stacks. For example, such correlation may be needed for investigation of any performance specific issues related to processing of client requests requiring execution of components across multiple stacks. The problem is often compounded in that each stack can be executing a large number of component instances (of different component types), potentially from different enterprise applications.

### BRIEF DESCRIPTION OF THE DRAWINGS

Example embodiments of the present invention will be described with reference to the accompanying drawings briefly described below.

FIG. 1 is a block diagram illustrating an example environment (computing system 100) in which several aspects of the present invention can be implemented.

FIG. 2 is a block diagram depicting additional details of computing system 100 of FIG. 1, illustrating the manner in which an enterprise application is implemented based on different components hosted on different stacks in one embodiment.

FIG. 3 is a flow chart illustrating the manner in which effective correlation of execution characteristics is facilitated in an embodiment.

FIGS. 4A-4B together depicts portions of a monitoring data that indicates the components of different stacks that are of interest, in one embodiment.

FIGS. 5A-5C together illustrates the manner in which collected execution characteristics are displayed in one embodiment.

FIG. 6 is a block diagram illustrating the details of a digital processing system in which various aspects of the present invention are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

An aspect of the present invention provides for monitoring components of an enterprise application distributed across stacks. In an embodiment, a digital processing system receives a monitoring data indicating a first component and a second component of an enterprise application, with the monitoring data further indicating that the first component executes in a first stack and the second component executes in a second stack. The digital processing system collects execution characteristics of the two components and displays the collected execution characteristics of both the components.

According to another aspect, the execution characteristics for both the components are displayed on a common user interface for a same time window, such that a user (e.g., an administrator of the enterprise application) is facilitated to correlate the execution characteristics of different components executing across multiple stacks.

In an embodiment, the monitoring data is provided in the form of XML, such that the data can be declaratively specified by another user (e.g., a developer/packager of the enterprise application), who is more knowledgeable about the internal operation of the enterprise application.

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Environment

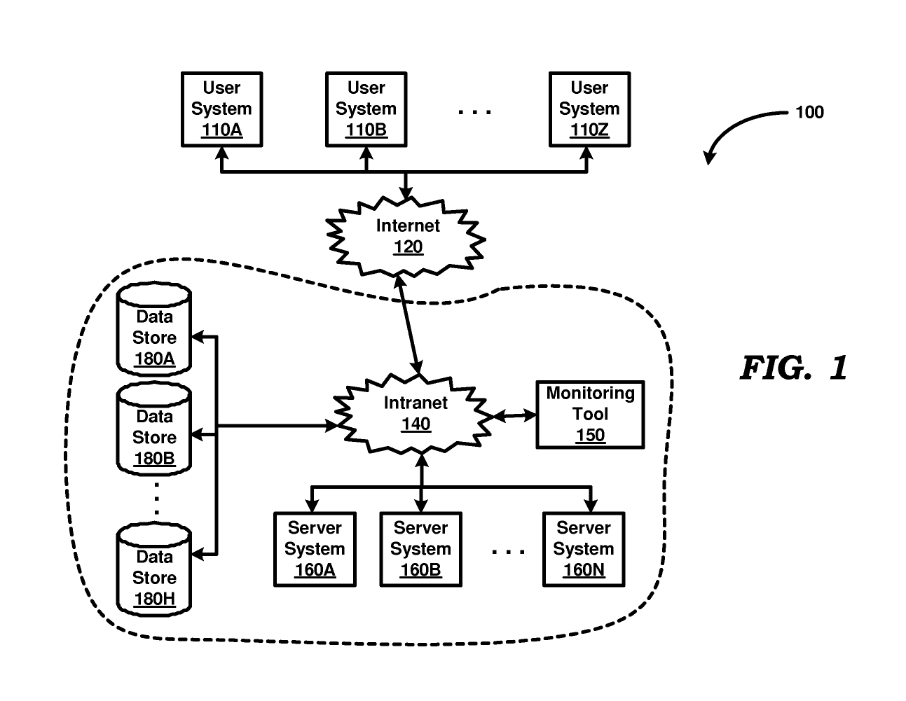

FIG. 1 is a block diagram illustrating an example environment (computing system 100) in which several aspects of the present invention can be implemented. The block diagram is shown containing user systems 110A-110Z, Internet 120, intranet monitoring tool 150, server systems 160A-160N and data stores 180A-180H.

Merely for illustration, only representative number/type of systems is shown in FIG. 1. Many environments often contain many more systems, both in number and type, depending on the purpose for which the environment is designed. Each system/device of FIG. 1 is described below in further detail.

Intranet 140 represents a network providing connectivity between monitoring tool 150, server systems 160A-160N, and data stores 180A-180H, all provided within an enterprise (as indicated by the dotted boundary). Internet 120 extends the connectivity of these (and other systems of the enterprise) with external systems such as user systems 110A-110Z. Each of intranet 140 and Internet 120 may be implemented using protocols such as Transmission Control Protocol (TCP) and/or Internet Protocol (IP), well known in the relevant arts.

In general, in TCP/IP environments, a IP packet is used as a basic unit of transport, with the source address being set to the IP address assigned to the source system from which the packet originates and the destination address set to the IP address of the target system to which the packet is to be eventually delivered. An IP packet is said to be directed to a target system when the destination IP address of the packet is set to the IP address of the target system, such that the packet is eventually delivered to the target system by intranet 140 and Internet 120.

Each of user systems 110A-110Z represents a system such as a personal computer, workstation, mobile device (e.g., cell phone), etc., used by users to generate client requests to enterprise applications executing in server systems 160A-160N. The requests may be generated using appropriate user interfaces. In general, a user system sends requests for performing specific tasks to enterprise applications and receives as corresponding responses the results of performance of the requested tasks. Each request is sent in the form of an IP packet directed to the desired server system (executing the enterprise application), with the IP packet including data identifying the requested task in the payload portion.

Each of data stores 180A-180H represents a non-volatile (persistent) storage facilitating storage and retrieval of a collection of data by enterprise applications executing in server systems 160A-160N. Some of data stores 180A-180H may be implemented as a corresponding database server using relational database technologies and accordingly providing storage and retrieval of data using structured queries such as SQL (Structured Query Language). Some of data stores 180A-180H may be implemented as a corresponding file server providing storage and retrieval of data in the form of files organized as one or more directories, as is well known in the relevant arts.

Each of server systems 160A-160N represents a server, such as a web/application server, executing enterprise applications capable of processing client requests received from users using user systems 110A-110Z. A server system may use data stored internally, external data maintained in data stores 180A-180H or that received from external sources (e.g., from the user) in performing such tasks. The server system then sends the result of performance of the tasks to the requesting end user system (one of 110A-110Z).

Monitoring tool 150, provided according to several aspects of the present invention, facilitates correlation of execution characteristics of various components of an enterprise application across multiple stacks. Monitoring tool 150 may be implemented within a separate digital processing system, or provided within one of server systems 160A-160N. The operation of monitoring tool 150 can be appreciated in conjunction with the details of implementation of an enterprise application. Accordingly the details of an example implementation are provided below.

### 3. Example Enterprise Application

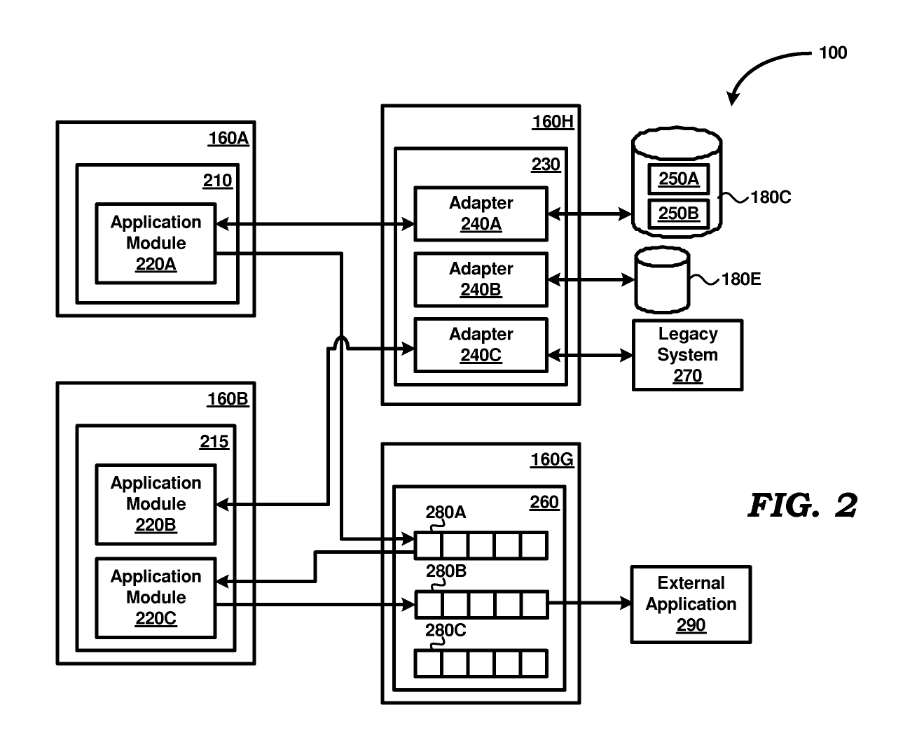

FIG. 2 is a block diagram depicting additional details of computing system 100 of FIG. 1, illustrating the manner in which an enterprise application is implemented based on different components hosted on different stacks in one embodiment. The block diagram is shown containing the some of the systems of FIG. 1 (160A-160B, 160G-160H, 180C and 180E) deployed with different stacks and components of the enterprise application.

Merely for illustration, only representative number/type of stacks/components is shown in FIG. 2. Many environments/enterprise applications often contain many more systems, stacks or components, both in number and type, depending on the purpose for which the environment/enterprise application is designed. Each block of FIG. 2 is described below in further detail.

Application stack 210, executing in server system 160A, represents a framework (containing a set of software routines) that provides an operating environment for executing application modules (such as 220A). The framework may also provide for simplification of development of the application modules. Application stack 210 may include multiple softwares that operate together to provide the operating environment. Application stack 210 may correspond to Oracle Application Server 10g that includes Java Virtual Machine, Oracle HTTP Server and OC4J (OracleAS Containers for Java EE), all available from Oracle Corporation, the intended assignee of the subject patent application.

Application stack 215, executing in server systems 160B, represents another application server type stack similar to application stack 210. Application stack 215 may correspond to another instance of the Oracle Application Server 10g, or to a different stack such as .NET Framework available from Microsoft Corporation. Application stack 215 provides an operating environment for executing application modules 220B-220C.

Each of application modules 220A-220C represents a corresponding component that incorporates the various business logic of the enterprise application. The business logic may be implemented by including software instructions according to a programming language (such as Java™ or C#™) supported by the underlying application stack 210/215. Alternatively and/or in addition, the business logic may be specified as business process consuming various external web services (using Business Process Execution Language (BPEL), well known in the arts).

Persistence stack 230, executing in server system 160H, represents a framework that provides an operating environment for implementing and executing components (such as adapters 240A-240C) that interface with persistence storages (such as databases) or other external enterprise information systems (such as legacy systems). In general, a persistence type stack manages connections and transactions from/to the storages/information systems, while also providing security and general life cycle management of the components. Persistence stack 230 may correspond to an implementation of Java EE Connector Architecture (JCA) in an application server such as WebSphere Application Server available from IBM Corporation.

Each of (resource) adapters 240A-240C represents a corresponding component that facilitates other components of enterprise application to access persistence storages (such as data stores 180C/180E) and/or enterprise information systems (such as legacy system 270). Thus, application modules 220A is shown invoking adapter 240A for accessing the data maintained in data stores 180C, while application module 220B is shown invoking adapter 240C for interfacing with legacy system 270.

It may be appreciated that data store 180C may be implemented as a database server using relational database technologies, and accordingly be viewed as a storage stack that facilitates hosting of storage components (of the enterprise application) such as tables and/or databases. Each of tables/databases 250A-250B accordingly represents a corresponding component hosted on storage stack/data store 180C that stores data used by other components of the enterprise application (via adapter 240A). Storage stack/data store 180C may correspond to an implementation of Oracle Database 11g available from Oracle Corporation or SQL Server 2008 R2 available from Microsoft Corporation.

Messaging stack 260, executing in server system 160G, represents a middleware framework that facilitates communication (sending/receiving of messages) between the components of an enterprise application (and/or external applications such as 290). In general, a messaging stack facilitates communication among components implemented on different machines (such as server systems 160A-160B) and/or using different technologies such as Java or .NET. Messaging stack 260 may correspond to an implementation of Java Message Service (JMS) in an Java 2 Enterprise Edition (J2EE) application server, both available from Oracle Corporation.

Each of messaging queues 280A-280C represents a corresponding messaging component that facilitates communication among the components of the enterprise application (such as application modules 220A-220C) and external application 290. Each messaging queue, identified by a name, represents a staging area (storage) where messages received from one component are maintained until retrieved and processed by another component. For example, message queue 280A is shown as receiving and maintaining messages from application module 220A, until retrieved and processed by application module 220C.

Thus, application modules 220A-220C, adapters 240A-240C, tables/database 250A-250B and message queues 280A-280B representing the different components of the sample enterprise application are implemented and hosted on different/multiple stacks provided in computing system 100. It may be appreciated that the various stacks may be provided as a single package (for example, Oracle SOA (service oriented architecture) Suite 11g available from Oracle Corporation) and also that the multiple components/stacks may be executed on a single server system.

Each of the stacks of FIG. 2 may be shared among other enterprise applications, with each enterprise application defining corresponding components (such as adapter 240B and 280C, not part of the sample enterprise application). It may be appreciated that computing system 100 may include a larger number and/or type of stacks, with each stack executing components from multiple enterprise applications.

At least based on the general operation described above, it may desirable to correlate the execution characteristics of components implemented across multiple stacks. Monitoring tool 150, provided according to several aspects of the present invention, facilitates such correlation of execution characteristics, as described below with examples.

### 4. Effective Correlation of Execution Characteristics

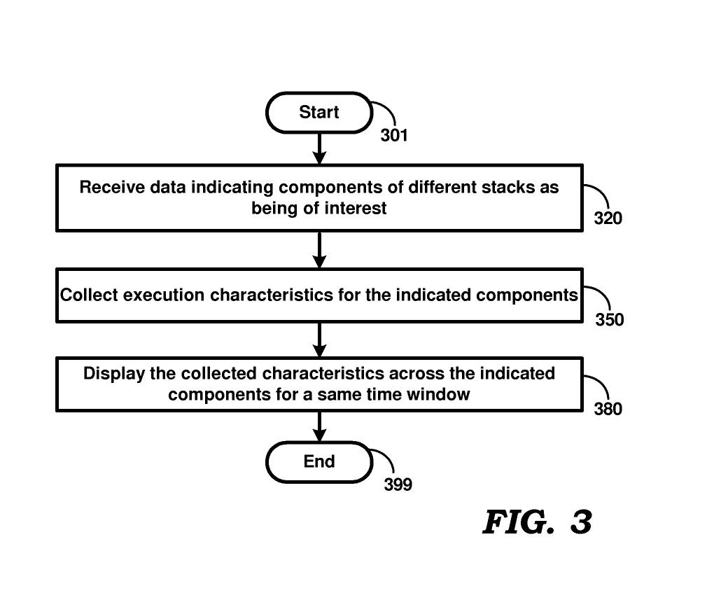

FIG. 3 is a flow chart illustrating the manner in which effective correlation of execution characteristics is facilitated in an embodiment. The flowchart is described with respect to FIGS. 1 and 2 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 301, in which control immediately passes to step 320.

In step 320, monitoring tool 150 receives data indicating components of different stacks, as being of interest. The combination of components are selected such that the related execution characteristics address a specific concern. For example, with the knowledge that specific ones of the application modules/adapters would be operative in processing a specific class (or even instance) of client requests, such specific modules/adapters may be specified in the data if the performance of the application in processing the specific class of requests is of interest (or of concern, etc.).

In step 350, monitoring tool 150 collects execution characteristics of the indicated components. Collection entails interfacing with the corresponding monitoring entity (for example, the corresponding stack, if the stack is designed to monitor and measure the characteristics of interest), and retrieving the values representing execution characteristics of interest.

Some of the execution characteristics may be computed based on the retrieved values. Other execution characteristics may correspond to characteristics of the specific stack when hosting and/or during execution of the indicated component. Collection may also entail storing the retrieved values, for example, in a persistent (non-volatile) storage for later use.

In step 380, monitoring tool 150 displays the collected characteristics across the indicated components for a same time window (or same duration). Assuming that the processing of a request occurs without substantial delay in each component, the collected execution characteristics would identify potentially any bottlenecks in the monitored components.

In one embodiment, the collected characteristics are displayed on a common user interface. A common user interface implies that execution characteristics collected from different components are displayed simultaneously on a display screen such that the correlation of characteristics across at least two components is simplified. The flowchart ends in step 399.

By having access to execution characteristics of the specified components of interest, an administrator is provided potentially only pertinent information for the specific concern (noted in step 320), thereby simplifying the analysis/interpretation of the information. In addition, since the displayed information relates to the same time window, the correlation of characteristics of different components is further simplified.

Such focused information is facilitated to be obtained using a declarative approach in which a first user specifies the key components for the specific concern, and a second user can then simply view the output generated in accordance with the flowchart of FIG. 2. For example, the first user can be a developer/packager of the enterprise application, who has the knowledge of the working of various components, as relevant to the concern. The second user can be an administrator (less knowledgeable of internal operation of the enterprise application) of computing system 100, whose task of monitoring and identifying issues related to the specific concern, is simplified.

The manner in which a developer/packager of the enterprise application can declaratively specify the components of different stacks, as being of interest, is described below with examples.

### 5. Sample Monitoring Data

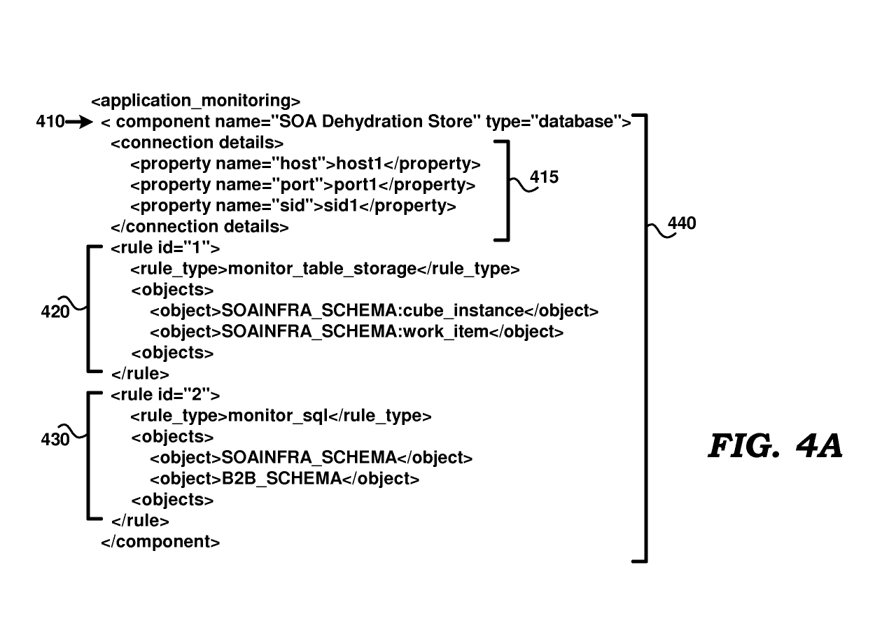

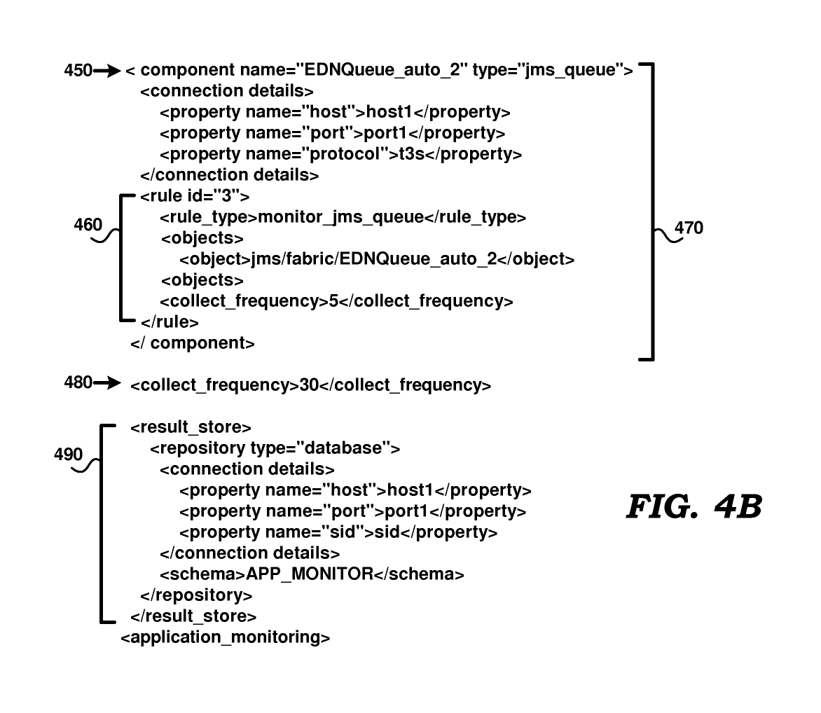

FIGS. 4A-4B together depicts portions of a monitoring data that indicates the components of different stacks that are of interest, in one embodiment. Though the monitoring data is shown as being specified according to extensible markup language (XML), in alternate embodiments, the monitoring data may be specified using any convenient other formats.

Broadly, a developer/packager of an enterprise application specifies as part of the monitoring data the key components of the enterprise application, the different stacks in which the key components operate, the specific execution characteristics to be correlated and the time window in which such correlation is to be performed. Thus, data portion 440 specifies the details of a first component, while data portion 470 specifies the detail of a second component.

Data portion 410 specifies the components hosted on a stack named “SOA Dehydration Store” and of type “database” (implying a storage type stack such as data store 180C). Data portion 415 specifies the details of connecting to data store 180C. Data portions 420 and 430 respectively indicate the execution characteristics to be collected and displayed. In particular, data portion 420 indicates that the storage size of “SOAINFRA_SCHEMA:cube_instance” and “SOAINFRA_SCHEMA:work_item” tables/components are to be monitored, while data portion 430 indicates that the SQL queries directed to the “SOAINFRA_SCHEMA” and “B2B_SCHEMA” databases/components are to be monitored.

Data portion 450 specifies the components hosts on a stack named “EDNQueue_auto_{—}2” and of type “jms_queue” (implying a messaging/middleware type stack such as messaging stack 260). Data portion 460 indicates that the queue execution characteristics of “jms/fabric/EDNQueue_auto_{—}2” message queue/component are to be monitored. Data portion 480 indicates that the frequency of collecting the information from the indicated components is 30 minutes.

Data portion 490 indicates the details of the repository in which the collected values of the execution characteristics for the indicated components are to be maintained. In particular, data portion 490 specifies a database named “APP_MONITOR” and the connection details for the repository.

The components of other types of stacks (such as application and persistence) may be similarly specified. It may be appreciated that for storage components such as tables/databases, the execution characteristics of either the storage components and/or the corresponding adapters (used to access the storage components) may be specified as being of interest. Furthermore, monitoring data may also specify the specific execution characteristics of the stacks to be collected.

Thus, a developer/packager of the enterprise application is facilitated to indicate the specific components of different stacks, as being of interest. The monitoring data may then be shipped along with the enterprise application package, and later copied to a pre-defined location for retrieval by monitoring tool 150. Alternatively, monitoring tool 150 may be designed to download (from a vendor site) the monitoring data, in response to an administrator indicating that s/he wishes to correlate the execution characteristics of the key components related to a specific concern.

Monitoring tool 150, after receiving the monitoring data of FIGS. 4A and 4B, retrieves execution characteristics specified by data portions 420, 430 and 460 of the components “SOA Dehydration Store” and “EDNQueue_auto_{—}2”, and then stores the retrieved characteristics in the database schema named “APP_MONITOR (as indicated by data portion 490).

It should be appreciated that the specific details provided for specification of the monitoring data and the extent of data collected is merely illustrative. Alternative embodiments can be employed, without departing from the scope and spirit of several aspects of the present invention. Some of such alternative embodiments are noted briefly below.

In one alternative embodiment, a developer may simply specify only the components of the stacks, without having to indicate the specific execution characteristics. Monitoring tool 150 may collect and display all the available execution characteristics of the indicated components.

In another alternative embodiment, monitoring tool 150 may collect only the execution characteristics of the indicated components. This implies that the execution characteristics of other components of the enterprise application are not collected, thereby potentially reducing the monitoring overhead and/or data transfer overhead.

In yet another alternative embodiment, monitoring tool 150 collects the characteristics for all the components deployed on the stacks indicated in the monitoring data. Only when displaying, the collected data is filtered according to the components and characteristics specified in the monitoring data.

Monitoring tool 150, thereafter displays the collected characteristics across the indicated components for a same time window, as described below with examples.

### 6. Displaying Execution Characteristics

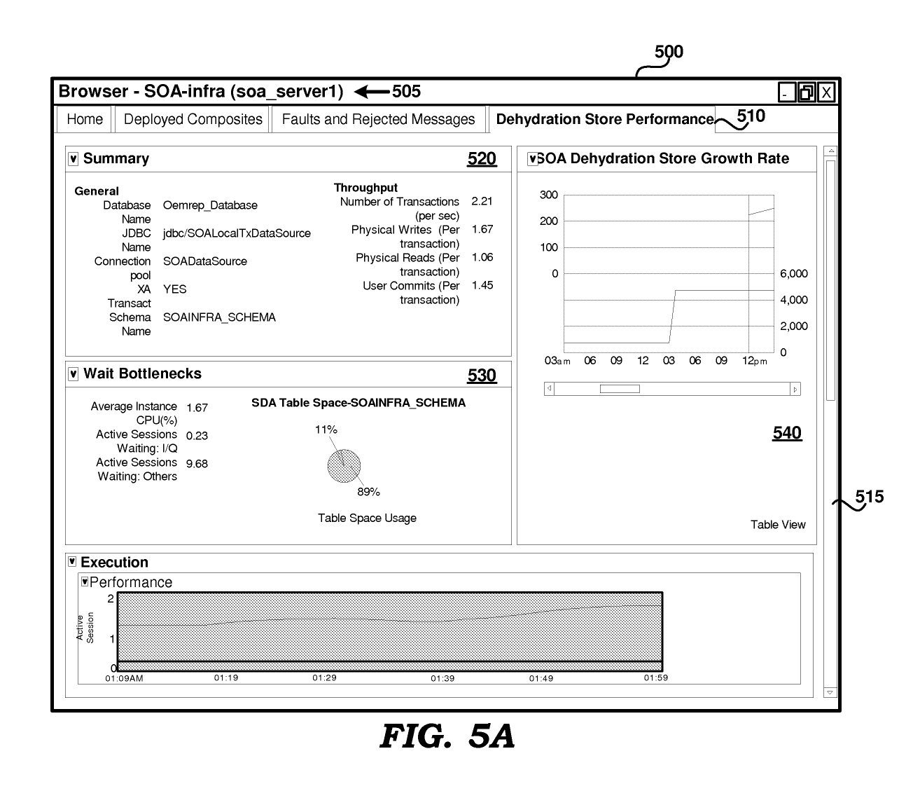

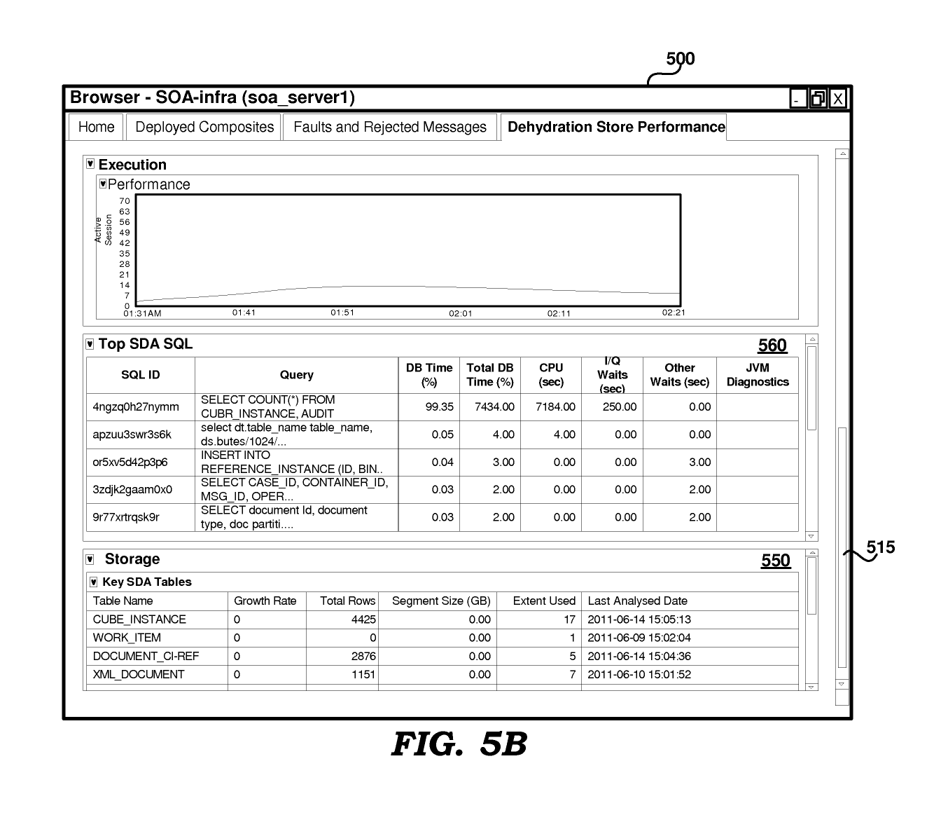

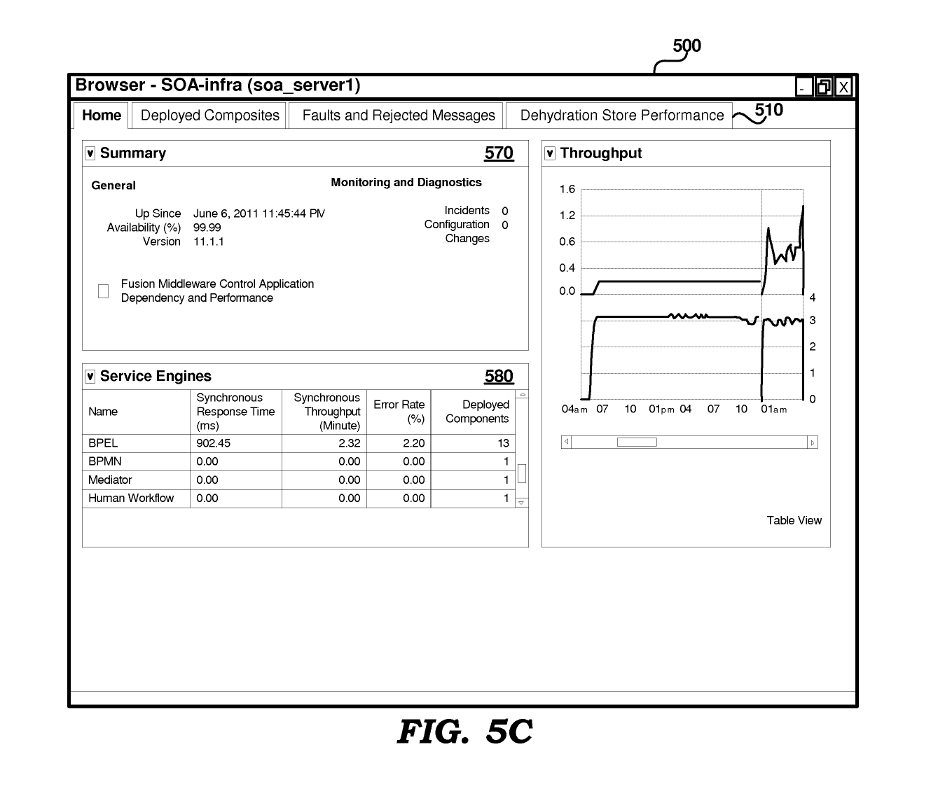

FIGS. 5A-5C together illustrates the manner in which collected execution characteristics are displayed in a common user interface in one embodiment. Display area 500 represents a portion of a user interface displayed on a display unit (not shown) associated with server systems 160A (or any other system) executing monitoring tool 150. Display area 500 may be provided by monitoring tool 150, in response to a request from a user/administrator to view the execution characteristics of the components of the enterprise application.

Referring to FIG. 5A, text 505 indicates that the information collected from the server system named “SOA-infra” is being displayed, while the selected tab “Dehydration Store Performance” in display area 510 indicates that the execution characteristics for components specified in the persistence stack is being displayed in display area 500. Display area 520 provides the general/common execution characteristics related to the components as well as the traffic and latency information for the component, while display areas 530 and 540 displays the execution characteristics corresponding to different components indicated in the monitoring data.

In particular, display area 520 provides aggregated information of the I/O waits that may possibly lead to delay in SQL execution, thereby causing performance impact on the specific application. Display areas 530 and 540 also display the storage size of the various tables/objects specified in the monitoring data of FIGS. 4A/4B. The storage size information may be useful in configuring and tuning the storage parameters.

A user may also scroll down using scroll bar 515 to view display area 500 shown in FIG. 5B. It may be observed that additional execution characteristics are being displayed in display area 500 of FIG. 5B. In particular, display area 560 is shown displaying the SQL queries directed to the database/objection specified in the monitoring data of FIGS. 4A/4B, while display area 550 displays the sizes of the different tables in the database.

Referring to FIG. 5C, the selected tab “Home” in display area 510 indicates that the execution characteristics for components specified in the application stack is being displayed in display area 500. Display area 570 provides the general/common execution characteristics related to the enterprise application, while display area 580 displays the execution characteristics corresponding to different service engines (part of stacks) executing the components of the enterprise application.

It should be noted that that the information displayed in the user interface of display area 500 corresponds to the components specified in the monitoring data of FIGS. 4A/4B. For example, the information shown in display area 530 and 550 corresponds to monitoring data in data portion 420, while the information shown in display area 560 corresponds to monitoring data in data portion 430.

In general, the user interface of display area 500 provides extended visibility across the different components of an enterprise application hosted on multiple stacks. Such information is useful in proactive detection (early warning) of the problems related to performance and availability. The correlation view is also helpful in trend analysis of the execution characteristics for the different components and its impact on the enterprise application.

It should be appreciated that the features described above can be implemented in various embodiments as a desired combination of one or more of hardware, executable modules, and firmware. The description is continued with respect to an embodiment in which various features are operative when the software instructions described above are executed.

### 7. Digital Processing System

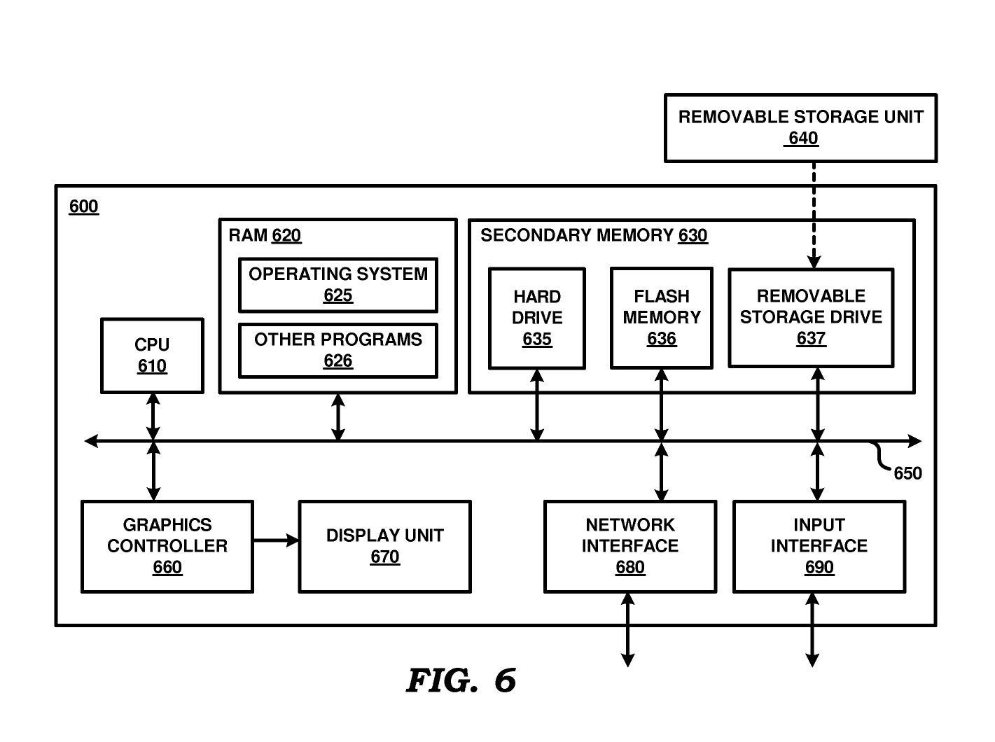

FIG. 6 is a block diagram illustrating the details of digital processing system 600 in which various aspects of the present invention are operative by execution of appropriate executable modules. Digital processing system 600 may correspond to any system executing monitoring tool 150.

Digital processing system 600 may contain one or more processors (such as a central processing unit (CPU) 610), random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present invention. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions constituting shared environment 625 and/or user programs 626 (such as softwares forming the stacks, etc.). Shared environment 625 contains utilities shared by user programs, and such shared utilities include operating system, device drivers, virtual machines, flow engine, etc., which provide a (common) run time environment for execution of user programs/applications.

Graphics controller 660 generates display signals (e.g., in RGB format) to display unit 670 based on data/instructions received from CPU 610. Display unit 670 contains a display screen to display the images defined by the display signals (such as the portions of the user interfaces shown in FIGS. 5A-5C). Input interface 690 may correspond to a keyboard and a pointing device (e.g., touch-pad, mouse) and may be used to provide the user inputs required for several aspects of the present invention. Network interface 680 provides connectivity to a network (e.g., using Internet Protocol), and may be used to communicate with other connected systems (such as user systems 110A-110Z, server systems 160A-160N, etc.) of FIG. 1.

Secondary memory 630 may contain hard drive 635, flash memory 636, and removable storage drive 637. Secondary memory 630 may store the data (for example, portions of monitoring data shown in FIG. 4, etc.) and software instructions (for example, for performing the steps of FIG. 3), which enable digital processing system 600 to provide several features in accordance with the present invention.

Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable storage medium having stored therein computer software and/or data. However, the computer (or machine, in general) readable storage medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present invention described above.

It should be understood that numerous specific details, relationships, and methods are set forth to provide a full understanding of the invention. For example, many of the functions units described in this specification have been labeled as modules/blocks in order to more particularly emphasize their implementation independence.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

### 8. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of monitoring components of an enterprise application hosted on multiple stacks, said method being performed in a digital processing system, said method comprising:
receiving a monitoring data indicating a first component and a second component of said enterprise application, wherein said monitoring data further indicates that said first component is hosted on a first stack and said second component is hosted on a second stack;
collecting a first set of execution characteristics for said first component and a second set of execution characteristics for said second component; and
displaying both of said first set of execution characteristics and said second set of execution characteristics.

2. The method of claim 1, wherein said displaying displays both of said first set of execution characteristics and said second set of execution characteristics for a same time window on a common user interface,
whereby a first user is facilitated to correlate the execution characteristics across different components hosted on multiple stacks.

3. The method of claim 2, further comprising:
enabling a second user to declaratively specify said monitoring data, wherein said receiving receives said monitoring data after said enabling.

4. The method of claim 3, wherein said second user specifies said monitoring data according to an eXtensible Markup Language (XML) format.

5. The method of claim 2, wherein said monitoring data further indicates a first execution characteristic for said first component and a second execution characteristic for said second component,
wherein said displaying displays only said first execution characteristic for said first component and only second execution characteristic for said second component.

6. The method of claim 5, wherein said collecting collects only said first execution characteristic for said first component and only second execution characteristic for said second component in response to said monitoring data indicating said first execution characteristic for said first component and second execution characteristic for said second component.

7. The method of claim 2, wherein said first stack is an application stack, said second stack is a persistent stack,
wherein said monitoring data further indicates a third component as executing in a messaging stack,
wherein said collecting collects a third set of execution characteristics for said third component,
wherein said displaying displays said third set of execution characteristics also for said same time window on said common user interface,
whereby said first user is facilitated to correlate the execution characteristics of the components executing in said application stack, said persistent stack and said messaging stack.

8. The method of claim 7, wherein said monitoring data also indicates a duration of said same time window.

9. A machine readable medium storing one or more sequences of instructions for causing a system to monitor components of an enterprise application hosted on multiple stacks, wherein execution of said one or more sequences of instructions by said one or more processors contained in said system causes said system to perform the actions of:
receiving a monitoring data indicating a first component and a second component of said enterprise application, wherein said first component is hosted on a first stack and said second component is hosted on a second stack;
collecting a first set of execution characteristics for said first component and a second set of execution characteristics for said second component; and
displaying, in a common user interface, both of said first set of execution characteristics and said second set of execution characteristics for a same time window,
whereby a first user is facilitated to correlate the execution characteristics across different components hosted on multiple stacks.

10. The machine readable medium of claim 9, said actions further comprising:
enabling a second user to declaratively specify said monitoring data, wherein said receiving receives said monitoring data after said enabling.

11. The machine readable medium of claim 10, wherein said second user specifies said monitoring data according to an eXtensible Markup Language (XML) format.

12. The machine readable medium of claim 9, wherein said monitoring data further indicates a first execution characteristic for said first component and a second execution characteristic for said second component,
wherein said displaying displays only said first execution characteristic for said first component and only second execution characteristic for said second component.

13. The machine readable medium of claim 12, wherein said collecting collects only said first execution characteristic for said first component and only second execution characteristic for said second component in response to said monitoring data indicating said first execution characteristic for said first component and second execution characteristic for said second component.

14. The machine readable medium of claim 9, wherein said first stack is an application stack, said second stack is a persistent stack,
wherein said monitoring data further indicates a third component as executing in a messaging stack,
wherein said collecting collects a third set of execution characteristics for said third component,
wherein said displaying displays said third set of execution characteristics also for said same time window on said common user interface,
whereby said first user is facilitated to correlate the execution characteristics of the components executing in said application stack, said persistent stack and said messaging stack.

15. The machine readable medium of claim 14, wherein said monitoring data also indicates a duration of said same time window.

16. A computing system comprising:
a client system used by a first user;
a plurality of server systems to host components of an enterprise application on multiple stacks, wherein a first server system of said plurality of server system provides a first stack and a second server system of said plurality of server systems provides a second stack;
a monitoring tool operable to:
receive a monitoring data indicating a first component and a second component of said enterprise application, wherein said first component is hosted on said first stack and said second component is hosted on a second stack;
collect a first set of execution characteristics for said first component and a second set of execution characteristics for said second component; and
display, on a common user interface in a display unit associated with said client system, both of said first set of execution characteristics and said second set of execution characteristics for a same time window;
whereby said first user is facilitated to correlate the execution characteristics across different components hosted on multiple stacks in said plurality of server systems.

17. The computing system of claim 16, further comprising:
a second client system used by a second user,
wherein said monitoring tool is further operable to enable said second user to declaratively specify said monitoring data, wherein said monitoring tool receives said monitoring data after said enabling.

18. The computing system of claim 17, wherein said second user specifies said monitoring data according to an eXtensible Markup Language (XML) format.

19. The computing system of claim 17, wherein said monitoring data further indicates a first execution characteristic for said first component and a second execution characteristic for said second component,
wherein said monitoring tool collects only said first execution characteristic for said first component and only second execution characteristic for said second component in response to said monitoring data indicating said first execution characteristic for said first component and second execution characteristic for said second component,
wherein said monitoring tool displays only said first execution characteristic for said first component and only second execution characteristic for said second component.

20. The computing system of claim 19, wherein said first stack is an application stack, said second stack is a persistent stack,
wherein said monitoring data further indicates a third component as executing in a messaging stack provided by a third server system of said plurality of server systems,
wherein said monitoring tool collects a third set of execution characteristics for said third component, and displays said third set of execution characteristics also for said same time window on said common user interface,
whereby said first user is facilitated to correlate the execution characteristics of the components executing in said application stack, said persistent stack and said messaging stack.
